(19) United States
(12) Patent Application Publication
(10) Pub. No.: US 2019/0281384 A1
(43) Pub. Date: Sep. 12, 2019

(54) Features of rotatable modular speaker

(71) Applicant: Minglong YANG, Guangdong (CN)

(72) Inventor: Minglong YANG, Guangdong (CN)

(21) Appl. No.: 16/281,113

(22) Filed: Feb. 21, 2019

(30) Foreign Application Priority Data
Mar. 6, 2018 (CN) 201820304404.3

(51) Int. Cl. H04R 1/40; H04R 1/02

(52) U.S. Cl. CPC H04R 1/403; H04R 2201/025; H04R 1/023; H04R 1/025

(57) ABSTRACT

The utility model provides a rotatable combined speaker, which relates to the field of speaker. It discloses a rotatable combined speaker. The rotatable combined speaker comprises a rotating device, which is used for a combined connection between the speakers. The utility model USES the contact between metals to realize the connection of electrical conduction between the speakers through the rotary device, and the number of speakers can be increased according to the user's demand through the design of the structure of the rotary device. The utility model solves the problem of winding the connecting wires between the speakers during the rotation of the rotary speaker.

### BACKGROUND OF THE INVENTION

The utility model relates to the field of electronic products, in particular to a rotary combined speaker.

As people more and more high to the requirement of the quality of life, speaker, as a kind of enjoy music indispensable auxiliary equipment, among them, the people in order to achieve in all directions to appreciate music has become more convenient, the utility model can rotate the speakers, existing of speakers that can rotate between speakers and speaker is connected by wires, in view of the use of wires, frequently, because of the length of the wire when rotating limit or winding problem, lead to limits the rotation Angle of the speakers, do not facilitate the rotation of the speakers. According to the needs of users, when they want to increase the number of rotating speakers, they cannot meet the needs of users due to the limitation of wire length or the design problem of speaker structure.

### BRIEF SUMMARY OF THE INVENTION

Based on this, it is necessary for the existing technical problems and provide a kind of rotatable combined speaker, can increase the number of speakers, according to the requirements of the user at the same time solve the rotary speaker wire winding problems in the process of rotation, through the contact between the metal, achieve the purpose of the electric conduction, speakers when rotating electric conduction sustainable uninterrupted.

In order to solve the existing technical problems, the utility model discloses a rotatable combined speaker, which comprises a rotating device, which is used for a combined active connection between the speakers; the rotary device is provided with a circular boss and a clamping cover. The clamping cover is provided with a clamping cavity suitable for the circular boss. The circular boss is fitted into the clamping cover. Circular convex platform is described including the first must have a pin and a second positioning pin, described the circular convex platform is equipped with the first must have a pin hole and a second positioning pin hole, the first must have a pin and a second positioning pin respectively through the first pin hole and a second positioning pin hole connected to the first power side is negative connection, described in the card or cover and the rest is equipped with metal another metal nut, described and rest metal another metal nut described respectively connected to the second power supply side is negative connection, described in the rest metal another conflict with the described the first must have a pin, described in the metal nut conflict with the described a second positioning pin, The rotatable combined speaker is always connected with the metal face and the metal nut in contradiction with the first positioning pin and the second locating pin respectively when rotating.

Further, rotatable combined speakers including base speakers, speakers, the second speaker 1 and 3 speakers, described base speakers including total power cord and the fixed seat, the first fixing plate fixed in the above mentioned base one end of the speaker, as described in the first block in the middle is equipped with the first total bore power input and the total power input; The first speaker comprises a first power cord, a second fixed base and a first circular boss. Described the first speaker is at the end of the second block, on the other side has described in the first round convex platform, as described in the first round convex platform is equipped with 3, positioning pin, positioning pin 4, 3 dowel pin holes and positioning pin hole 4, described in the second block in the middle has described and mentioned in the first total power input holes and the total power input hole corresponding to the first metal pin and a second metal pin, as described in the first metal pin and a second metal pin first described respectively through the total bore power input and the total power input, the total is the cathode of the power cord around it is the first metal pin and a second through the nut is fixed on the metal pin. The first fixing seat is connected to the second fixing seat. The first metal pin and the second metal pin are connected to the positive and negative poles at one end of the first power line respectively. The third locating pin and the fourth locating pin are connected to the positive and negative poles at the other end of the first power line respectively through the third locating pin hole and the fourth locating pin hole. Described in the second speakers including the second power line, the second round convex sets and the second card cover, as described in the second speaker at one end with the second round convex, other side is equipped with a second card cover, described in the second round convex platform is equipped with positioning pins 5 and 6 positioning pin, positioning pin hole 5 and 6 positioning pin hole, described the second card or cover with the second metal and a second metal nut. Described in the second round of the convex positioning pin 5 and 6 pins through the positioning pin hole 5 and 6 positioning pin hole, respectively, and at the end of the second power cord is negative connection, described the second card or cover and the rest of the second metal another second nut, respectively, and the second power cord across the electrodes at the other end of the connection, as described in the first round convex platform with the second card or cover, as described in the third position with the top of the dowel pin and 4 rest, respectively, and the second metal another conflict and a second metal nut, described the first speaker complete connection with the second speaker; Described the third speaker including 3, power cord, 3 card cover, as described in the third speaker is equipped with the third card or cover at one end, on the other side as the closed end, described the third card or cover and the rest is equipped with the third metal another third metal nut, as described in the third and third rest metal another metal nut and at the end of the third power cords are negative connection, described in the second round convex platform with the third card or cover card, described in the fifth positioning pin and rest with the top of the dowel pin 6 respectively with the third metal another conflict and the third metal nut, described the second speaker connected with a third speaker.

Further, the clamping cover is provided with an opening end, and the circular boss moves the clamping end inward from the opening end, and the opening end is provided with elastic compression parts to prevent the circular boss from sliding out from the opening end.

Further, the base speaker is provided with a speaker module.

Further, the clamping cover of the rotary device is provided with an upper cover and a lower cover, and the metal sheet is arranged between the upper cover and the lower cover, which are connected by screws.

Further, the rotatable combined speaker cabinet is provided with a speaker cabinet, the number of the speaker cabinet is greater than one, the speaker cabinet is provided with at least one speaker, and the speaker cabinet is provided with a speaker hole consistent with the number of speakers. Further, described a speaker net speaker cabinet.

The beneficial effect of the utility model is as follows: through the design of the connection structure between the speakers of the utility model, the problem of wire winding when the speaker rotates can be effectively prevented, and the number of speakers can be increased according to the different needs of users.

### BRIEF DESCRIPTION OF THE DRAWINGS

FIG. 1 is a split diagram of the rotary device of the utility model;

FIG. 2 is the split diagram of the utility model's base speaker;

FIG. 3 is the split diagram of the first speaker of the utility model;

FIG. 4 is the split diagram of the second speaker of the utility model;

FIG. 5 is the split diagram of the utility model's third speaker;

FIG. 6 is the combination diagram of the base speaker of the utility model;

FIG. 7 is the first speaker combination diagram of the utility model;

FIG. 8 is the combination diagram of the second speaker of the utility model;

FIG. 9 is the combination diagram of the third speaker cabinet of the utility model;

FIG. 10 is the assembly diagram of the rotatable combination speaker of the utility model;

FIG. 11 is the overall picture of the rotatable combined speaker of the utility model.

### DETAILED DESCRIPTION OF THE INVENTION

In order to further understand the features, technical methods & the specific purpose and function of the utility model, the utility model is further described in detail in combination with the attached drawings and the specific implementation mode below.

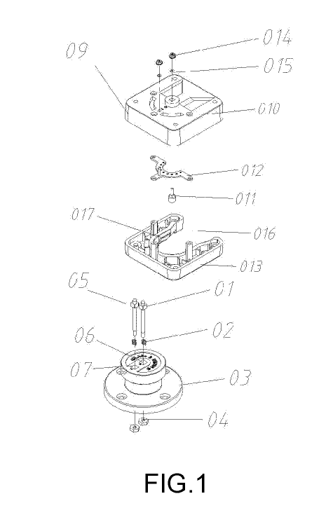

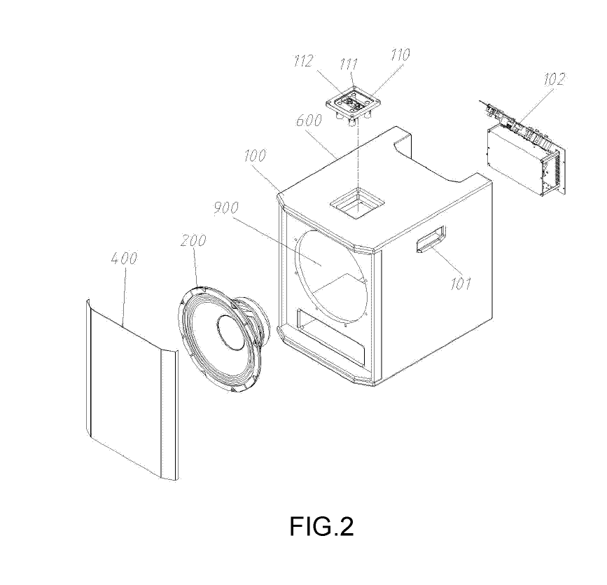

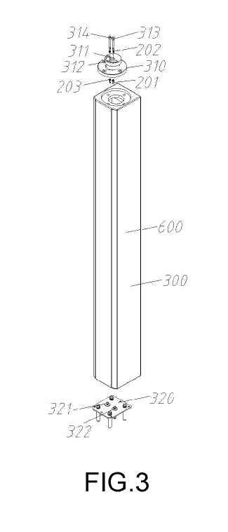

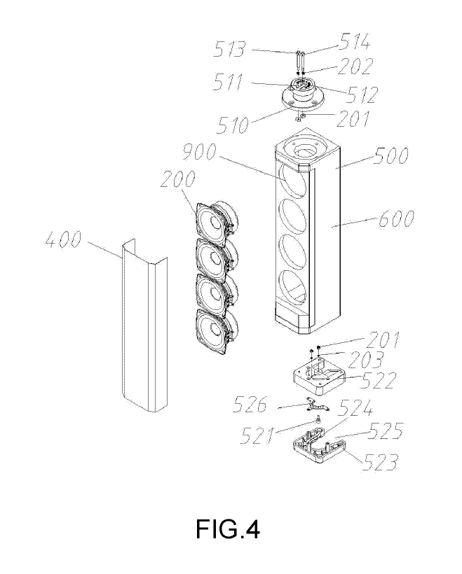

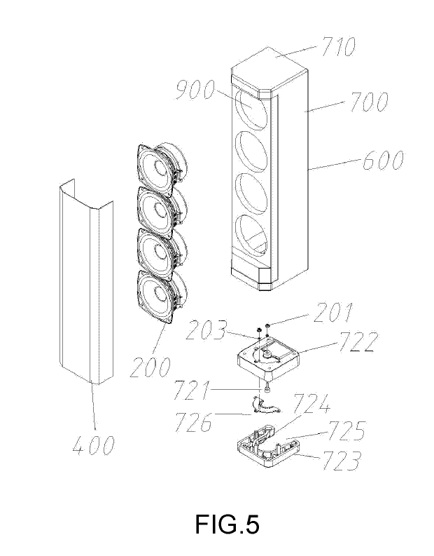

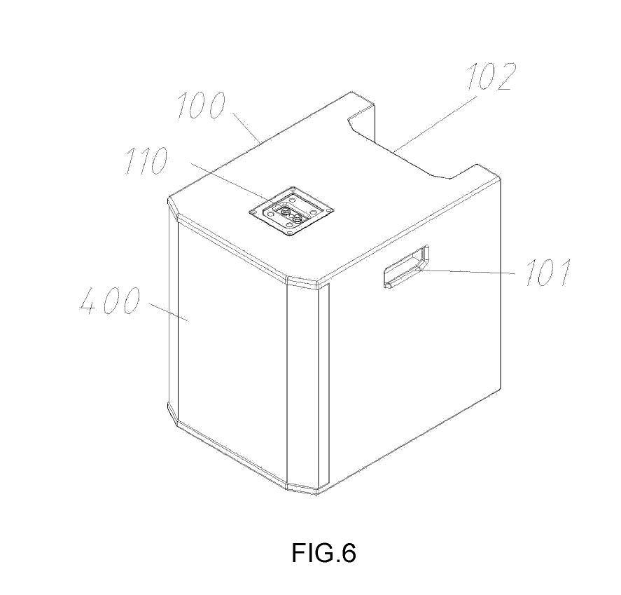

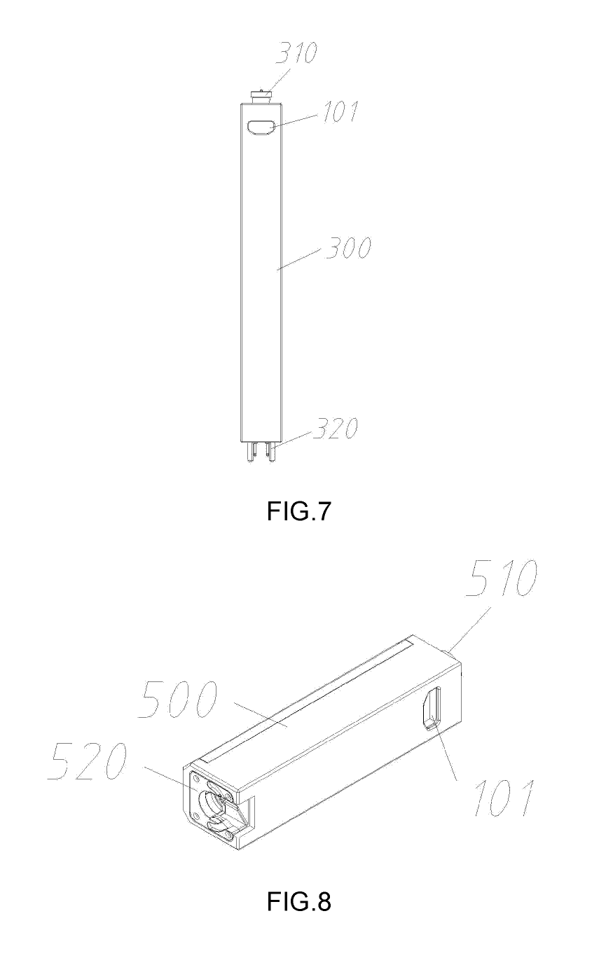

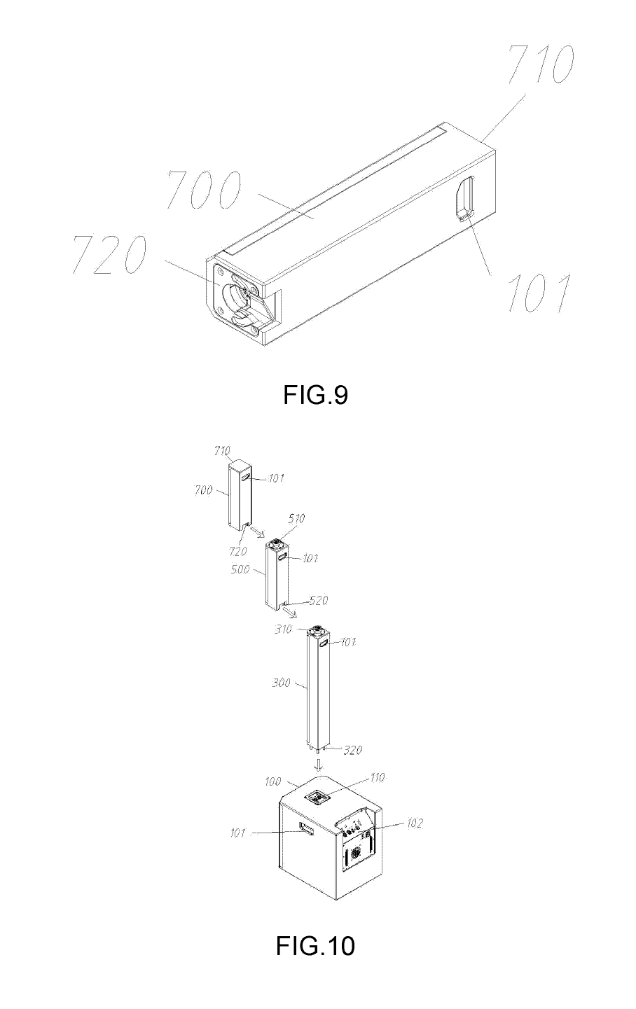

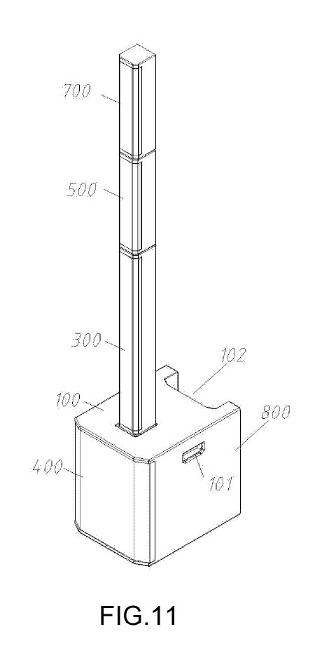

Please refer to FIGS. 1 to 11. The utility model discloses a rotatable combined speaker, and the rotatable combined speaker comprises a rotating device, which is used for a combined active connection between the speakers, The rotary device is provided with a circular lug 03 and a clamping cover 09, and the clamping cavity suitable for the circular lug 03 is provided with the clamping cover 09 inside the clamping cover, and the circular lug 03 card is arranged in the clamping cover 09, and the speakers are connected to complete the function of relative rotation: Described circular convex 03 also includes the first must have a pin and a second positioning pin 05, 01 circular convex platform 03 has described the first must have a pin hole 6 and a second positioning pin hole. 07, first must have a pin and a second positioning pin 05 01 respectively through the spring 02 with the first a pin hole 06 and 07 second positioning pin hole through the screw 04 across the electrodes and the first power supply connection end connection. The clamping cover 09 is provided with a metal sheet 012 and a metal nut 011, the clamping cover is provided with an upper cover 010 and a lower cover 013, and the upper cover 010 and the lower cover 013 are fixed and connected by screws. The metal face 012 and the metal nut 011 are respectively fixed with gasket 015 and screw 014 by protruding through the upper cover 010 through hole, and the metal face 012 and the metal nut 011 are respectively fixed with the positive and negative poles of the second power supply connection end through screw 014. The metal face 012 is in conflict with the first position pin 01, Described metal nut 011 conflict with the described a second positioning pin 05, described the circular convex 03 by card and the open end of cover 09 016 move into a card or cover 09 and 017 pressure by elastic compression parts, described rest rotatable combined speakers when rotating metal another 012 and 011, respectively, with the first metal nut must be described a pin and a second positioning pin 05 01 conflict always stay connected, conflict between metal and metal, realizes the electric conduction continue uninterrupted. The connection between speakers is realized by means of a rotating device and the electrical conduction connection is realized by means of metal resistance, which solves the problem that the speaker is prone to wire winding during the rotation.

Example 1, a rotatable combined speaker 800 including base cabinet 100, the first speaker, 300, the second speaker 300 and 700, the third speaker base speakers including total power cord and the first permanent seat 110, described the first fixed 110 through screws in one end of the base cabinet 100, described the first permanent seat 111 among 110 sets the total power input hole and second total power input hole 112.

The first speaker 300 includes the first power cord, the second fixed base 320 and the first circular boss 310. One end of the first speaker 300 is provided with the second fixed base 320 and the other end is provided with the first circular boss 310. The second fixed base 320 and the first circular boss 310 are fixed on the first speaker 300 through screws. The first circular boss 310 is provided with the third locating pin 313, the fourth locating pin 314, the third locating pin hole 311 and the fourth locating pin hole 312, and the second fixing seat 320 is provided with the first metal pin 321 and the second metal pin 322 corresponding to the first general power input hole 111 and the second general power input hole 112, Described in the first metal pin 321 and the second metal pin 322 first described respectively through the total power input power input hole 111 and the second at the 112, the total power cord is negative respectively by nut and described the first metal pin 321 and the second metal pin 322 connections, as described in the first fixed bridge mentioned in 110 and the second fixed 320 connection is complete, as described in the first metal pin and a second metal pin 321 and 322 respectively at the end of the first power cord is negative connection, The third locating pin 313 and the fourth locating pin 314 pass through spring 202 respectively and then pass through the third locating pin hole 311 and the fourth locating pin hole 312 respectively and are fixedly connected with the positive and negative poles at the other end of the first power line through gasket 203 with screw 201. The second speaker 500 comprises a second power cord, a second round lug 510 and a second clip cover 520, and a second round lug 510 is arranged at one end of the second speaker. The other end is provided with a second clamping cover 520, the second circular boss 510 and the second clamping cover 520 are respectively fixed on the second speaker 500 through screws. Described in the second round convex platform is equipped with positioning pin 5 513 510, 514, the fifth positioning pin hole positioning pin 6 511 and 6 positioning pin hole 512, described the second card cover 520 rest with the second metal on another us $526 and a second metal nut, 521, the second card or cover 520 is equipped with a second card cover 523, 522 and the second card under cover described in the second round convex 510 fifth pins and locating pin 6 514 513 through the spring of 202 and then through the positioning pin hole 511 5 and 6 positioning pin hole with screws 512 and 201 respectively at the end of the second power cord is negative connection. Described in the second card cover 520 rest of the second metal another us $526 by 526 and the second nut screws in the second card or cover, respectively, in 520 through the second card cover screw 522 through 201 and the second power cord across the electrodes at the other end of the fixed connection, first round convex platform 310 from the second card cover 520 open end 525 move, and through the second card or cover the elastic compression parts 524 compression card, the first round convex sets of 310 and the second card or cover 520 card is completed, The upper ends of the third locating pin 313 and the fourth locating pin 314 conflict with the second metal face plate 526 and the second metal nut 521 respectively, and the first speaker cabinet 300 is connected with the second speaker cabinet 500: Described the third speaker 700 including 3, power cord, 3 card cover 720, described the third speaker at one end is equipped with the third card cover 720, on the other side as the closed end of 710, the third card cover 720 rest with the third metal another us $720 and the third metal nut 721, the third card or cover 720 is equipped with the third card cover 722, 722 and the third card under the lid rest the third metal another 726 through 726 and the third metal nut screws in the third card closed cover 723 between 722 and the third card under cover, Rest the third metal another 726 and the third metal nut 721 respectively through the third card cover 722 203 and 203 through the screw hole through the gasket is negative at the end of the third power cord connection, the second round convex platform 510 from the third card cover 720 open end 725 move, and through the third card or cover the elastic compression parts 724 compression card, the second round convex platform 510 and the third card cover 720 card is completed, as described in the fifth dowel top respectively in 513 and locating pin 6 514 726 and rest with the third metal another third metal nut conflict, 712, The second speaker 500 is connected with the third speaker 700. Through the above operation, the assembly connection of the rotatable combination speaker is completed, and the uninterrupted electrical conduction between speakers is realized through the metal-to-metal contact. The base speaker cabinet 100 is equipped with the speaker module 102, which includes the main power switch, power input jack, audio input and output jack, and the speaker module 102 is used to control the whole rotatable modular speaker system.

Base speaker 100 is equipped with a loudspeaker cabinet 600, a loudspeaker hole 900 & a 200, a horn speaker 200 through the screw on the speaker hole 900 fixed installation on loudspeaker cabinet 600, the second speaker 500 and the third speaker 700 is respectively equipped with a loudspeaker cabinet 600, 3 horns hole, 900, 3 loudspeakers 200, which through the screw on the speaker hole 900 fixed installation on the loudspeaker cabinet 600. The base speaker 100, the 2nd speaker 500 and the 3rd speaker 700 are respectively equipped with the speaker net cover 400, which is fixed on the speaker cabinet 600, and the speaker net cover 400 is used to protect the speaker 200 on the speaker cabinet 600 from damage.

Dock speaker 100, the first speaker 300, the second speaker 500, the third speaker 700 respectively set as one 101, which used for speaker's convenient install and safety through handlebar adhesive force during install & tear the speaker.

The above embodiments only express several ways of the utility model, and their descriptions are more specific, but they cannot be interpreted as restrictions on the scope of the patent of utility model. It should be pointed that, for the ordinary technical personnel in this field, however, under condition of not deviating from the conception of the utility model, some deformation and improvement can be made which all belong to the protection scope of the utility model. Therefore, the scope of protection of the utility model patent shall be subject to the attached claim.

What is claimed is:

1. Features of rotatable modular speaker: it comprises a rotating device used for active connection between modular speakers. The rotary device is provided with a circular boss and a clamping cover. The clamping cover is with a cavity to match the boss. The circular boss is fitted into the clamping cover and to complete the connection between speakers as well as relative rotation function. The boss includes primary location pin, secondary pin, and corresponding pinholes. The primary and secondary location pins respectively pass through the first and second pinholes to connect to the positive and negative terminals of the primary power. Provided with metal sheets and nuts on clamping cover, and the metal sheets and nuts are respectively connected to the positive and negative terminals of the secondary power, and the metal sheet contacts to first location pin, nuts to the second. Therefore the metal sheets and nuts are respectively linking to the first and second pins to keep in touch while speakers rotate.

2. According to claim 1, the rotatable modular speakers cover one base speaker, first column, second column and the third column. The base speaker includes main power cords and the first fixed seat which located on top side of base speaker. The first main power input hole and a second main power input hole are arranged in the middle of the first fixed seat. The first column contains first power cord, second fixed seat and the first circular boss. The first boss is fitted on top side of column 1, and it equipped with third and fourth location pin and the corresponding pinholes. The second fixed seat is mounted on bottom side of first column, and contains the first and second metal pins corresponding to the first and second main power input holes. The first metal pin and the second metal pin respectively pass through the first and second main power input holes. The positive and negative poles of the main power cord are respectively connected to the first metal pin and the second metal pin through the nut, and the first fixed seat is connected with the second seat, the first and second metal pins are respectively connected to the positive and negative terminal on one end of the first power cord; and the third location pin and the fourth pin respectively pass through the third and fourth pinholes to connect the positive and negative terminal on the other end of the first power cord. The second column contains the second power cord, second circular boss and second clamping cover. The second boss is mounted on top side of column 2, and equipped with fifth and sixth location pin and the corresponding pinholes. The second clamping cover, mounted on bottom side of second column, contains the second metal sheet and nut. The fifth and sixth location pins on second boss respectively pass through the corresponding pinholes to connect the positive and negative terminal on one end of second power cord. The metal sheets and nuts on second clamping cover are respectively connected to the positive and negative terminals on the other end of second power cord. The first boss is fitted to second clamping cover. The location pin 3 and 4 are respectively contacted to second metal sheet and nut and then complete the link between column 1 and column 2. The third column contains the third power cord and third clamping cover. The third clamp cover is mounted on bottom side of column 3, while the top side is closed end. The third cover is provided with the third metal sheet and nut and the sheet and nut are connected to the positive and negative terminal of the third power cord. The second circular boss is engaged with the third cover together with the location pin 5 and 6 respectively contacting with the third metal sheet and nut. Therefore column 2 and column 3 is connected.

3. According to claim 1, the rotary modular speaker is characterized in that the clamping cover is provided with an opening end to support the circular boss moves into the cover from the opening end. And the opening end is provided with elastic compression part to prevent the boss sliding out of the opening end.

4. According to claim 2, a rotatable modular speaker is characterized in that the base speaker is provided with a amplifier module.

5. Features of rotatable modular speaker in claim 1: the clamping cover of the rotary device is consisted with an upper cover and a lower cover, and the metal sheet is arranged between the upper and the lower cover and connected by screws.

6. According to items in claim 1, the features of rotatable modular speaker are lying in that it can be equipped with one cabinet speaker, even more. The speaker cabinet is provided with one woofer at least; the speaker cabinet is provided with the woofer supporting holes corresponding to the quantity of the woofers.

7. According to claim 6, a rotatable modular speaker is characterized by the each speaker front is covered with grille.
